(19) United States
(12) Patent Application Publication
(10) Pub. No.: US 2017/0116719 A9
(43) Pub. Date: Apr. 27, 2017

(54) APPARATUS AND METHOD FOR VERIFYING ACCURACY OF A COPY OF THE HOLY QURAN AND OTHER DOCUMENTS

(71) Applicant: Talal Abbas Marafie, Kuwait (KW)

(72) Inventor: Talal Abbas Marafie, Kuwait (KW)

(21) Appl. No.: 14/689,812

(22) Filed: Apr. 17, 2015

Related U.S. Application Data
(60) Provisional application No. 62/025,701, filed on Jul. 17, 2014.

(51) Int. Cl. G06T 7/00; G06K 9/03

(52) U.S. Cl. CPC G06T 7/001; G06K 9/03; G06T 2207/30144; G06T 2207/30176; G06K 2209/013

(57) ABSTRACT

A method and system for verifying the accuracy of a copy of the Holy Quran and other Arabic documents is disclosed. The method includes preparing a digital master of an Arabic document and sizing the digital image to preselected dimensions, making gamma corrections and converting gray images to black or white and comparing a printed copy with said digital master and marking differences to indicate artifacts and omissions.

### CROSS-REFERENCE TO RELATED APPLICATIONS

The present U.S. utility Patent Application claims priority to the U.S. Provisional Patent Application Ser. No. 62/025,701, filed on Jul. 17, 2014, the content of which is incorporated herein by reference in its entirety.

### FIELD OF INVENTION

This invention relates to system, method, and apparatus for verifying the accuracy of a copy of the Holy Quran and other documents, and more particularly, to a system and method for verifying the accuracy and identifying defects in a copy of the Holy Quran and other documents that are written in Arabic.

### BACKGROUND FOR THE INVENTION

Verification of copies of Arabic text with respect to a digital copy of a master copy of the same flawless Arabic text without any errors or defects is more difficult than verifying the accuracy of a document in English. This is particularly true when verifying the accuracy of copies of the Holy Quran. The problem is that in Arabic, the location of certain diacritic marks and dots, or omission or addition thereof, can and does change the letter and the meaning of a word and/or its interpretation. Therefore, it is vitally important to Muslims that a copy of the Holy Quran is accurate and does not include any inaccuracies, additions or omissions.

As understood by Applicant, the King Fand Complex for the Printing of the Holy Quran is the largest printer of copies of the Holy Quran in the world and prints approximately 14 million copies of the Holy Quran and translations thereof in many foreign languages. As understood, each Arabic copy is reviewed by three qualified editors to assure that each copy is accurate and contains no additions or omissions. It is also believed that during the printing months there are about 1,000 or so qualified editors who are employed to proofread the printed copies for accuracy.

A number of U.S. patents disclose methods for removing optical artifacts appearing in a scanned image of a book.

U.S. Pat. No. 8,134,759 to Albahri discloses an image capture apparatus that facilitates fast, easy and convenient image capture of the two opposing pages of hard to scan bound documents such as thick books. The image capture apparatus has special design features that conveniently and properly position bound documents to enable capturing distortion-free images without damage to the binding. The pressed down handle holding down the transparent surface is left up when the pages of the bound document need to be flipped for next page image capture. (See, FIG. 2 and Summary).

U.S. Patent Application Publication No. 2012/0014566 to Xu discloses a method for detecting motion quality errors of printed documents having text in a printing system including: printing a document having text lines, each text line comprising a plurality of characters; scanning the printed document to generate a scanned image; detecting positions in a process direction of the printing system of one of the text lines and characters in the scanned image; determining position errors in the process direction in the printed document based on the detected positions in the scanned image; determining at least one motion quality defect of the printing system in the process direction based on the determined position errors; and initiating an activity associated with said printing system in response to a motion quality error having been determined. A system for detecting motion quality error of printed documents is disclosed. (See Figures, paragraphs [0007]-[0023], and the claims).

U.S. Pat. No. 6,937,369 to Shih discloses an apparatus for positioning a scanning starting point of an image scanning apparatus includes a platen, carriage, and a number of marks. When using a scanner provided with a high image scanning quality, merging, two images is a way to promote image quality. After scanning the first chosen image of the document to be scanned once, the carriage moves half a pixel in the Y direction by mechanical adjustment to scan a second time. The two scanned images are then merged and a doubling of the scanning resolution is achieved. A first image with a resolution of 600 dpi obtained in the first scanning and a second image with a resolution of 600 dpi is then obtained in the second scanning after the carriage moves half a pixel. The second image has a displacement of half a pixel in respect to the first image.

Finally, U.S. Pat. No. 6,611,362 to Mandel discloses an automatic book page turner for imaging. As the individual pages of a book having a gutter and outside edge margins and being held at least partially open are being automatically sequentially turned over, in coordination therewith a flattening force is applied to the unimaged gutter margin areas of the book for flattening the pages after they have been at least substantially turned over, and unimaged outside edge margins of the book are clamped by automatic clamping members in coordination therewith, for appropriate page viewing and/or imaging. (See, Figures and Summary).

### SUMMARY OF THE INVENTION

The invention comprises and/or consists of a system and method for verifying the accuracy of a printed or digital copy of the Holy Quran and other documents in the Arabic language from a digital master. The steps include preparing an Arabic document and sizing a digital image to preselected dimensions. The next step calls for making gamma corrections and converting gray images to black or white wherein about 59% of lights are white (the 59% depends on the page background color and the text/font color). The printed copy and digital master are then compared and artifacts and omissions are highlighted on the copy. In some embodiments of the invention the artifacts and omissions are highlighted using different colors.

The invention will now be described in connection with the accompanying drawings wherein like elements are identified with like numbers.

### DESCRIPTION OF THE DRAWINGS

FIG. 1 is a perspective view of a printer or printing apparatus used for printing the Holy Quran;

FIG. 2 is a perspective view of the printed Holy Qurans on single sheets and stacked before being folded, cut and bounded;

FIG. 3 is a perspective view of a person hand-writing the Holy Quran or manually making manuscript changes by hand;

FIG. 4 is a perspective view of a person reviewing and proof reading the Holy Quran to manually identify defects in the text;

FIG. 5 is a perspective view of the Holy Quran folded into signatures;

FIG. 6 is a perspective view of the bounded printed Holy Qurans exiting from the printing apparatus;

FIG. 7 is a flow diagram illustrating exemplary steps in printing the Holy Quran;

FIG. 8 is a perspective view of an exemplary book scanner with the Holy Quran in a preparatory position prior to the scanning operation;

FIG. 9 is the perspective view of the book scanner scanning the Holy Quran;

FIG. 10 is a perspective view of an exemplary computer and a computer monitor displaying the scanned pages side-by-side on the computer monitor;

FIG. 10A is a schematic view of a system for comparing a perfect copy with a scanned image of a copy;

FIG. 11 is a print of a side-by-side comparison of an accurate text from the Holy Quran in scanned digital form with a scanned copy from the printed version and highlighted defects or ink blotches;

FIG. 12 is a print of a side-by-side comparison of an accurate text from the Holy Quran in scanned digital form with a scanned copy from the printed version and highlighted an exemplary phonetic misplacement of Arabic letters;

FIG. 13 is a print of a side-by-side comparison of an accurate text from the Holy Quran in scanned digital form with a scanned copy from the printed version is illustrated in which differences in artifacts are indicated by a first color and differences in omissions are indicated in a different color;

FIG. 14 is a print of a side-by-side comparison of an accurate text from the Holy Quran in scanned digital form with a scanned copy from the printed version is illustrated in which the first and second colors are superimposed on the artifacts and omissions, respectively;

FIG. 15 is an illustration of three Arabic characters;

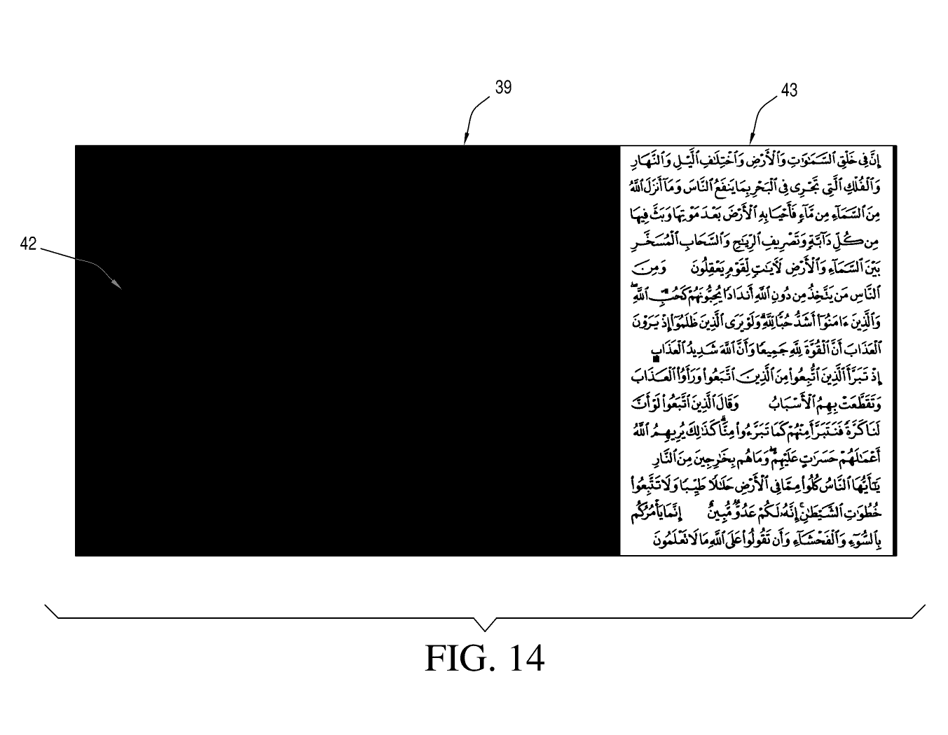

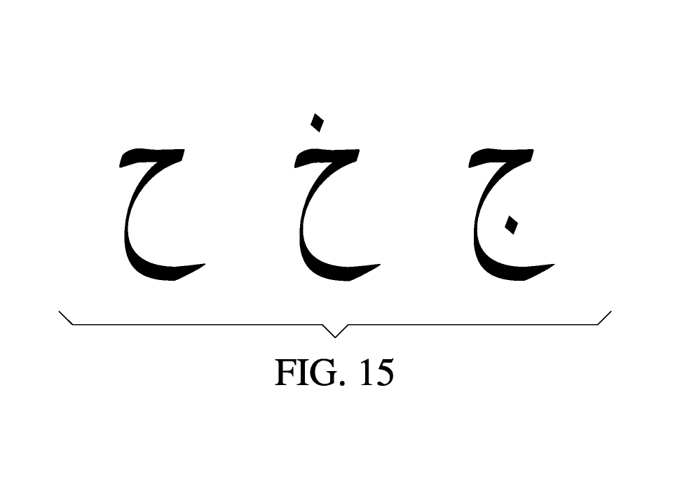

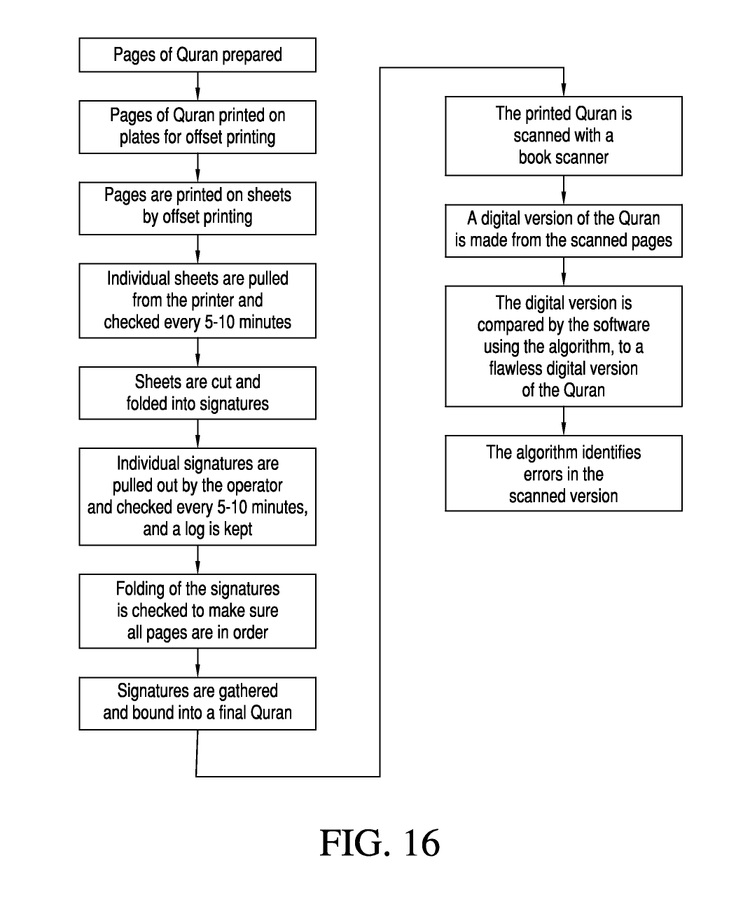

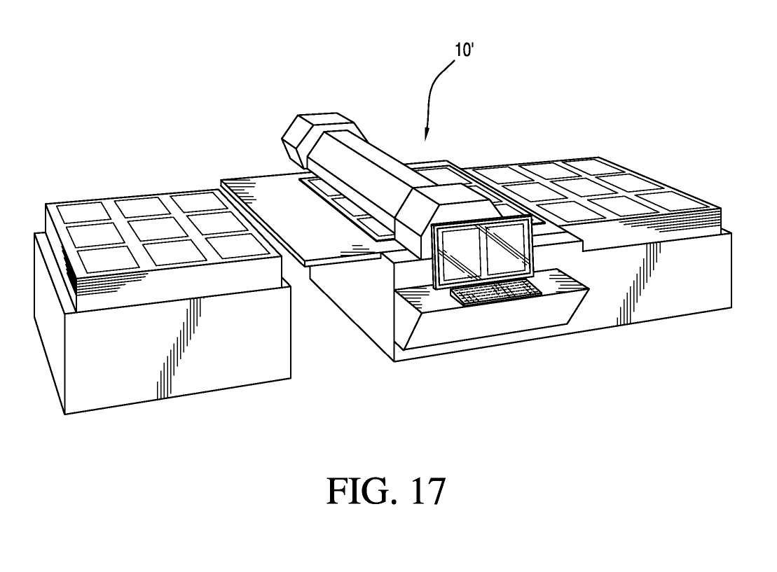

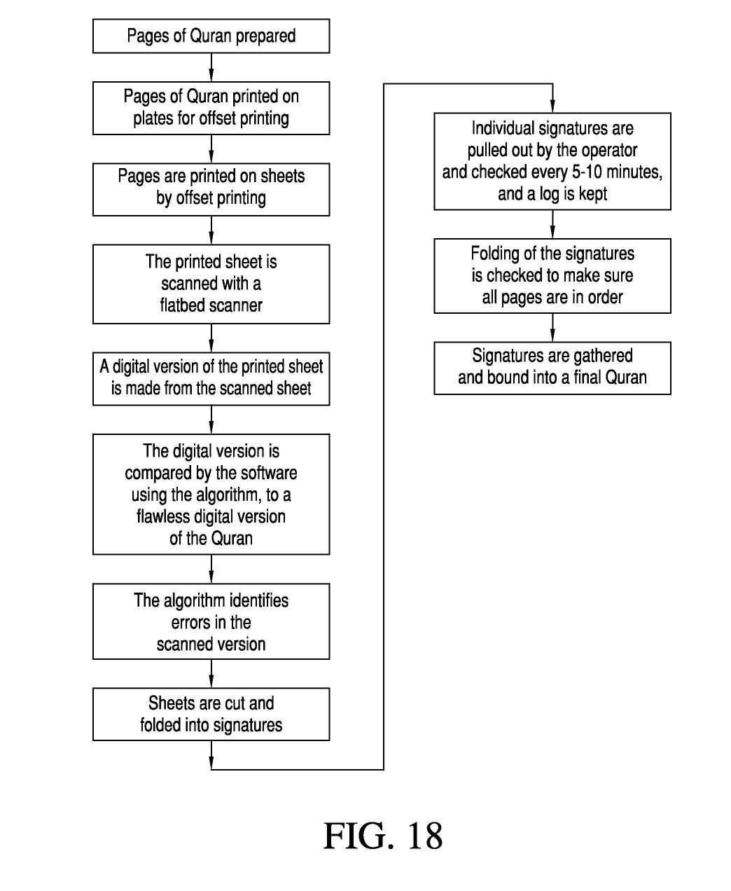

FIG. 14 is flow diagram illustrating the printing process and steps in printing of the Holy Quran followed by the steps of making the comparison using an algorithm;

FIG. 15 is a perspective view of an alternative scanner for scanning the Holy Quran using the flat print sheets of the Holy Quran; and,

FIG. 16 is a flow diagram of the steps in printing, scanning, and making the comparison of the flat printing of the Holy Quran in FIG. 15.

### DESCRIPTION OF SOME EMBODIMENTS OF THE INVENTION

This description is written for using Arabic as an example of the language used in the Holy Quran. However, other languages such as, but not limited to, Persian, Urdu, Pashto, Sindhi, Kurdish, and the present invention may also apply to languages with Roman or Latin scripts. Also, the description is written for authenticating a printed copy of the Holy Quran. However, hand-written manuscripts of the Holy Quran or any other text or book may be authenticated by the claimed method and process.

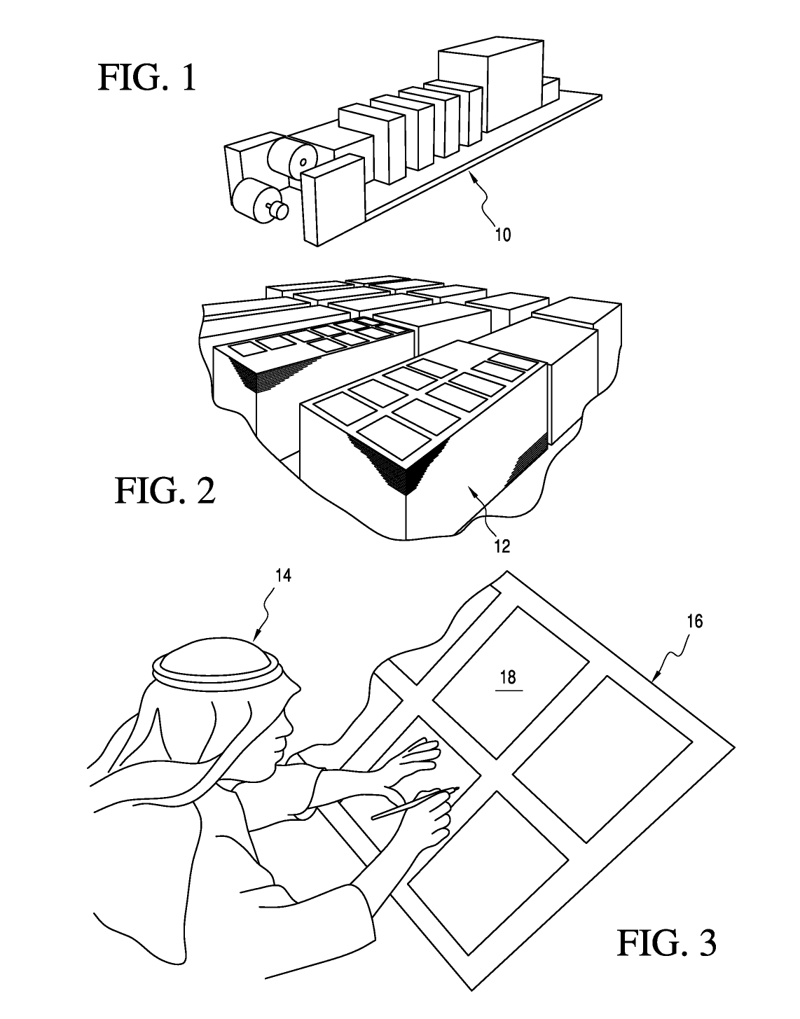

Referring to FIG. 1, a perspective view of a printer 10 that is used for offset printing of the Holy Quran. This printer can be a conventional off set printer in a facility for printing the Holy Quran.

Referring to FIG. 2, the printed Holy Qurans are stacked in sheet forms 12, preferably in 1 meter by 1 meter sheets, wherein each sheet may include, for example, 10 pages of the Holy Quran.

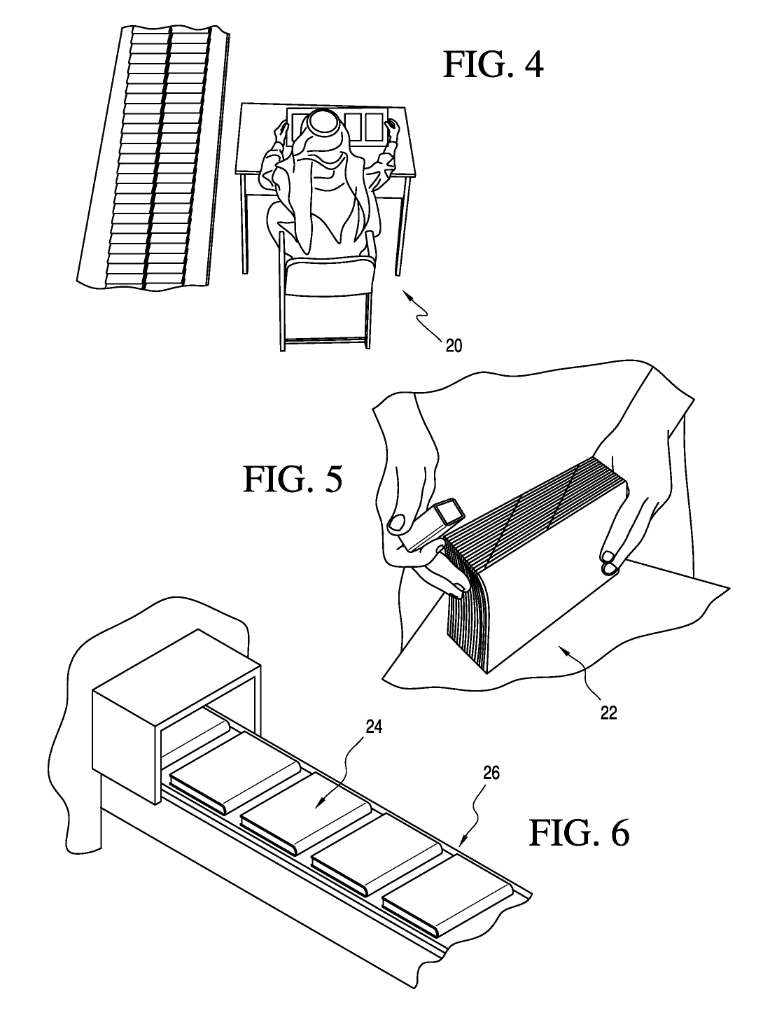

Referring to FIG. 3, a person 14 is illustrated manually reviewing and editing a single sheet 16 having a plurality of pages 18 of the Holy Quran. The manual changes are done in manuscript.

Referring to FIG. 4, a person 20 is positioned next to the conveyor where the printed sheets are conveyed from the printer and the person or quality reviewer is reviewing a sample sheet of the printed Holy Quran to identify any defects.

Referring to FIG. 5, a person is checking the folding of the signatures 22 of the printed Holy Quran to make sure all the printed pages are in order.

Referring to FIG. 6, the printed Holy Qurans 24 are moved along a conveyor system 26 in a completed form.

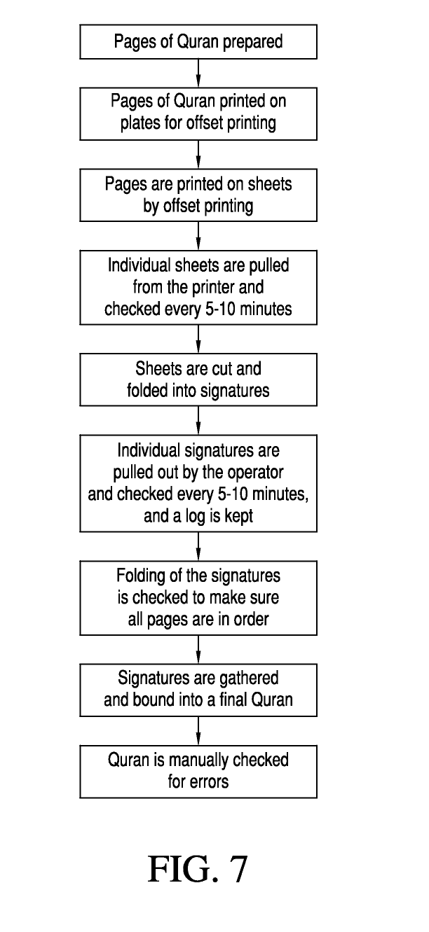

Referring to FIG. 7, the steps of the process of the printing the Holy Quran is outlined in the flow diagram. This printing process includes the steps of conventionally printing the Holy Quran using offset printing. In some embodiments, additional steps may be required. In some embodiments, some or at least one of the steps in the process can be removed. In some embodiments, the order of the steps may be altered.

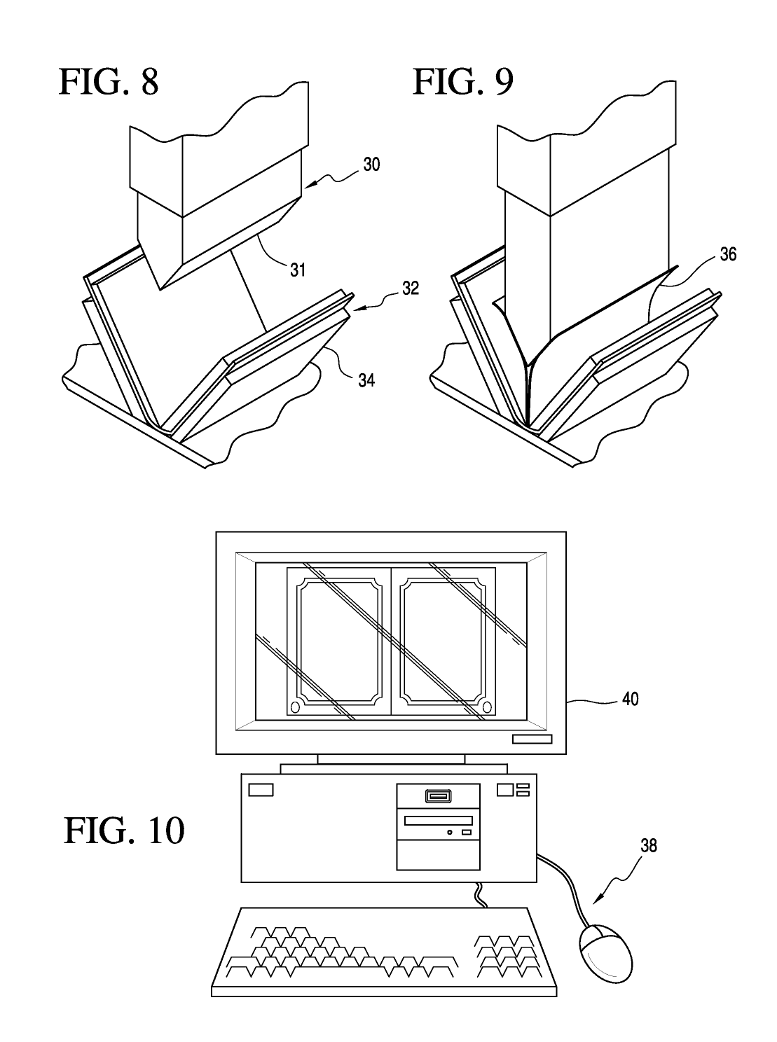

Referring to FIG. 8, a book scanner 30 is illustrated having a triangular scanning head 31, in which the book scanner is positioned prior to scanning the Holy Quran. The printed Holy Quran 32 is in a preparatory position relative to a book support member 34.

Referring to FIG. 9, the book scanner 30 is illustrated in operation wherein the scanning head 31 is scanning the two pages 36 of the Holy Quran.

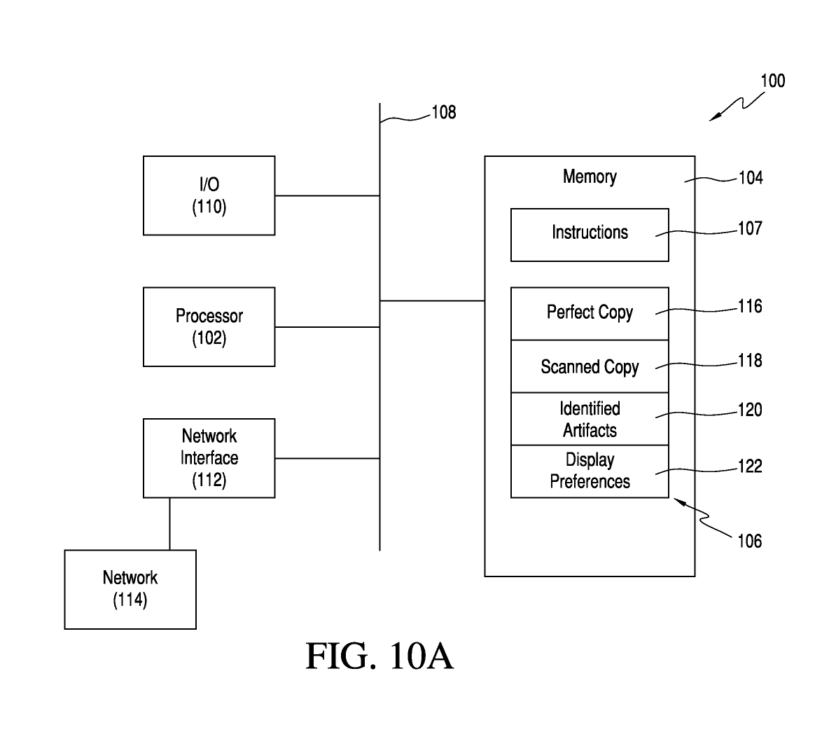

Referring to FIG. 10, a computer 38 having a hard drive, a processor, a power unit, and a monitor 40 is illustrated. The computer 38 is operably connected to the scanner and includes optical character recognition (OCR) software in which the scanned pages of the Holy Quran are converted to one of the digital formats of .pdf, JPEG. BMP, etc. and stored on the hard drive and displayed on the monitor.

Referring to FIG. 10A, a system 100 for scanning and comparing a perfect copy of the Holy Quran with a printed version is shown. System 100 includes a hardware processor 102 and a non-transitory, computer readable storage medium 104 encoded with, i.e., storing, the computer program code 106, i.e., a set of executable instructions. Computer readable storage medium 104 is also encoded with instructions 107 for interfacing other computers, scanners or other devices. The processor 102 is electrically coupled to the computer readable storage medium 104 via a bus 108. The processor 102 is also electrically coupled to an I/O interface 110 by bus 108. A network interface 112 is also electrically connected to the processor 102 via bus 108. Network interface 112 is connected to a network 114, so that processor 102 and computer readable storage medium 104 are capable of connecting to external elements via network 114. The processor 102 is configured to execute the computer program code 106 encoded in the computer readable storage medium 104 in order to cause system 100 to be usable for performing a portion or all of the operations as described in FIG. 14 or FIG. 16.

In some embodiments, the processor 102 is a central processing unit (CPU), a multi-processor, a distributed processing system, an application specific integrated circuit (ASIC), and/or a suitable processing unit.

In some embodiments, the computer readable storage medium 104 is an electronic, magnetic, optical, electromagnetic, infrared, and/or a semiconductor system (or apparatus or device). For example, the computer readable storage medium 104 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 104 includes a compact disk-read only memory (CD-ROM), a compact disk-read/write (CD-R/W), and/or a digital video disc (DVD).

In some embodiments, the storage medium 104 stores the computer program code 106 configured to cause system 100 to perform the method of FIG. 14 or FIG. 16. In some embodiments, the storage medium 104 also stores information needed for performing a method of FIG. 14 or FIG. 16 as well as information generated during performing the method FIG. 14 or FIG. 16, such as a perfect copy parameter 116, a scanned copy parameter 118, an identified artifacts parameter 120, a display preferences parameter 122 and/or a set of executable instructions to perform the operation of the method in FIG. 14 or FIG. 16.

In some embodiments, the storage medium 104 stores instructions 107 for interfacing with other computers, scanners or other devices. The instructions 107 enable processor 102 to generate instructions readable by the other components within the system 100 to effectively implement the method of FIG. 14 or FIG. 16.

System 100 includes I/O interface 110. I/O interface 110 is coupled to external circuitry. In some embodiments, I/O interface 100 includes a keyboard, keypad, mouse, trackball, trackpad, and/or cursor direction keys for communicating information and commands to processor 102.

System 100 also includes network interface 112 coupled to the processor 102. Network interface 112 allows system 100 to communicate with network 114, to which one or more other computer systems are connected. Network interface 112 includes wireless network interfaces such as BLUETOOTH, WIFI, WIMAX, GPRS, or WCDMA; or wired network interface such as ETHERNET, USB, or IEEE-1394. In some embodiments, the method of FIG. 14 or FIG. 16 is implemented in two or more systems 100, and information such as a perfect copy, a scanned copy, identified artifacts or display preferences is exchanged between different systems 100 via network 114.

System 100 is configured to receive information related to a perfect copy of the Holy Quran through I/O interface 110. The information is transferred to processor 102 via bus 108 and is then stored in computer readable medium 104 as perfect copy parameter 116. System 100 is configured to receive information related to a scanned copy 118 through I/O interface 110. The information is stored in computer readable medium 104 as scanned copy parameter 118. System 100 is configured to receive information related to display preferences through I/O interface 110. The information is stored in computer readable medium 104 as display preferences parameter 122.

During operation, processor 102 executes a set of instructions to determine whether any inaccuracy, omissions or additions are present in the scanned copy based on perfect copy parameter 116 and scanned copy parameter 118. Any identified artifacts are stored in computer readable medium 104 as identified artifacts parameter 120. Processor 102 further executes a set of instructions for modifying scanned copy parameter 118 to highlight identified artifacts based on display preferences parameter 122. Processor 102 further executes a set of instructions for displaying information stored in perfect copy parameter 116, scanned copy parameter 118 and identified artifacts parameter 120 based on display preferences parameter 122 to a user.

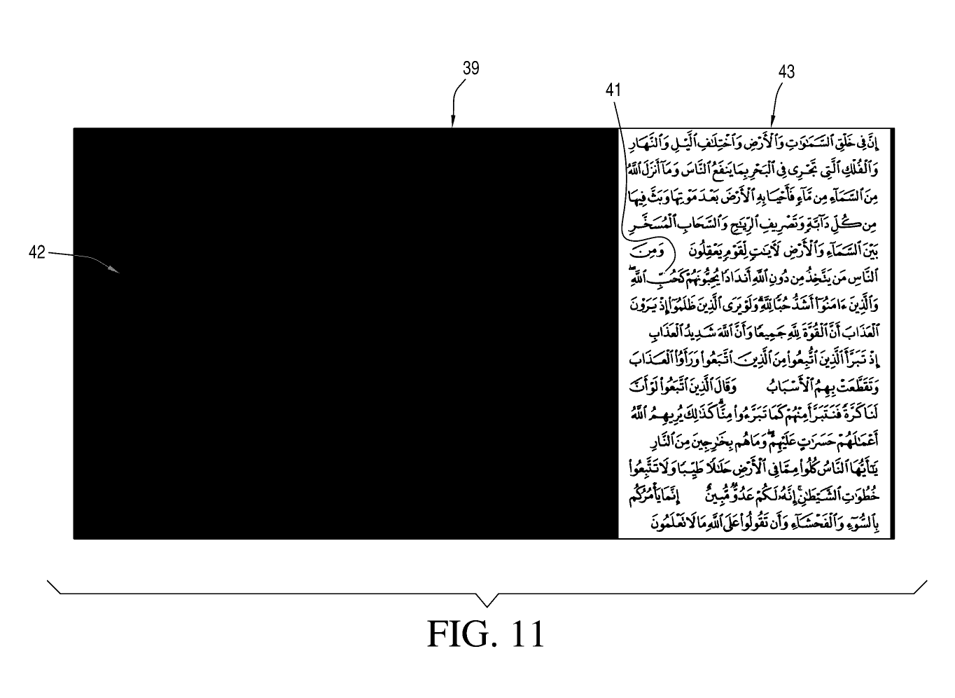

Referring to FIG. 11, a printed original and accurate text 39 from the Holy Quran is illustrated in the center, in which the original and perfect text of the Holy Quran can be provided with the text in blue ink with a black background. This unblemished and perfect version is available commercially in many digital formats such as, but not limited to, .pdf, JPEG, BMP, etc. The claimed system, software, and apparatus invention, which can run on any exemplary personal computers, compares a scanned version 43 of a printed text of the Holy Quran, in any image format and as an image, which also can be output in any digital formats, and is illustrated on the right in FIG. 11, which can be provided in black ink on a yellow background, and makes a comparison with the original and unblemished text 39. If the scanned version includes additional artifacts, defects, or ink blotches 41 as a result of printing, copying, or scanning, those additional artifacts will be marked for visual inspection by, for example, a blue square or dot 42 on left side of FIG. 11, which are coordinated with the vertical and horizontal position in which the defect or artifact is present in the text. It is noted that this layout may be on the computer monitor, and this comparison may be done as the scanning is done two-page at a time, or alternatively, it can be done as a single operation of comparing the whole Holy Quran, or yet alternatively, it can be done one page at a time.

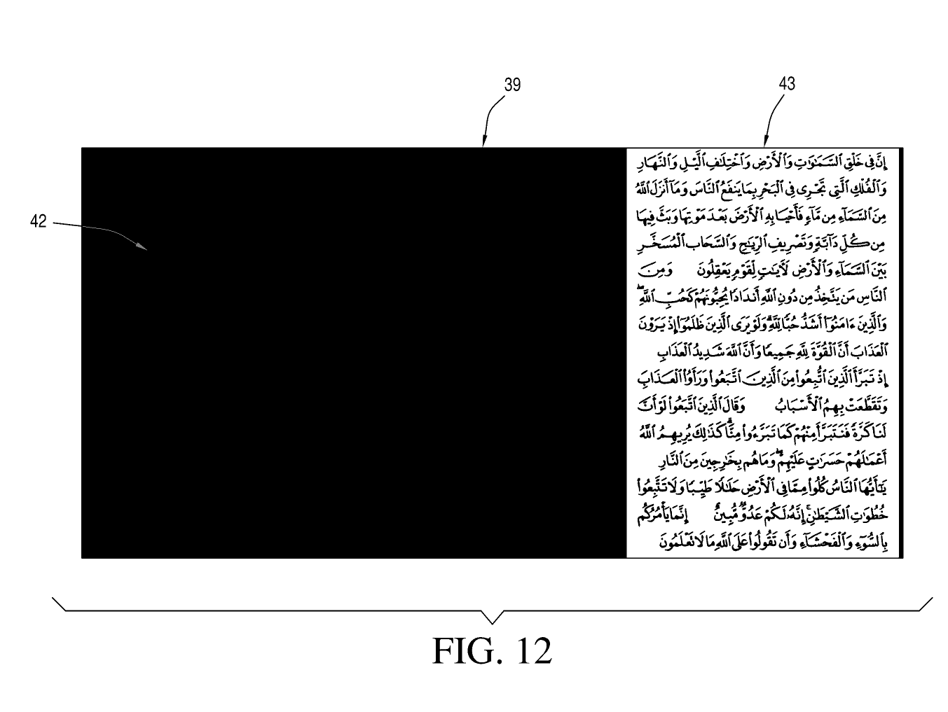

Referring to FIG. 12, similar to the situation in FIG. 11, if the scanned version 43 includes omissions or variations in the Arabic letters (e.g. dots on the top or bottom of the letter), those omissions will be identified in, for example, in blue squares or dots 42 on the left hand side of the screen. Therefore, by making a comparison with a perfect and unblemished copy of the Holy Quran, the scanned and reproduced version can be quality checked and provided with a visual means as to the presence of any artifacts, ink blotches, paper imperfections, dusts, or omissions of any characters and dots of the letters, with the aim to produce an accurate copy of the Holy Quran.

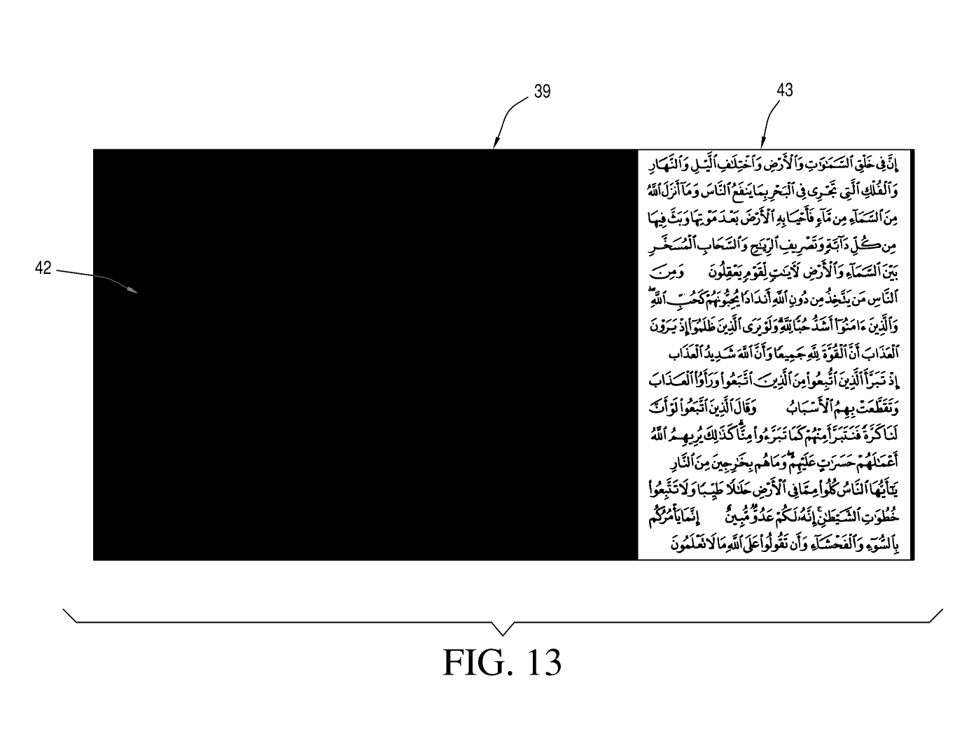

Referring to FIG. 13, a print of a side-by-side comparison of an accurate text from the Holy Quran 43 in scanned digital form with a scanned copy 39 from the printed version is illustrated in which differences in artifacts are indicated by a first color and differences in omissions are indicated in a different color.

Referring to FIG. 14, a print of a side-by-side comparison of an accurate text from the Holy Quran 43 in scanned digital form with a scanned copy 39 from the printed version is illustrated in which the first and second colors are superimposed on the artifacts and omissions, respectively.

It is also noted that the comparison step between the image of the perfect and unblemished copy of the Holy Quran with the image of the printed version and copy to which is to be authenticated can be done by making the comparison in a single page by single page image, or it can be done with the entirety of the Holy Quran, i.e. all the pages together as a single run and step.

One requirement of the claimed invention is that the scanned pages should be flat and this could be achieved by ensuring that during the scanning process pages are flat or by using flattening algorithms the flattening process ensures better results. If the pages are curved during the scanning process it leads to misleading information when the comparison is done.

In general, the invention is a method for maintaining the integrity of the Quranic text when making a copy (e.g., printing) or scanning an image. Modem Arabic text can be scanned, copied, printed, or otherwise imaged. The fonts used can pose difficulties for distinguishing different markings. The problem is increased for Quranic text. The Holy Quran was revealed in Arabic over a thousand years ago. The content was revealed in the spoken language as commonly understood at that time. Today, to properly understand the Quranic text, one who wishes to properly understand the Holy Quran should pay attention to understanding the content, pronunciations, inflections, emphasis, end of sentences, pauses, and other characteristics that were contained originally but may not be adequately recognized using simplified modern Arabic text and fonts. To preserve the original content, markings, such as “dots,” may be used to signal the reader as to certain characteristics of the text. Often, Quranic text may be provided in handwriting instead of mechanical print form.

Unfortunately, present scanning, imaging, and printing technology is not adequately capable of reproducing Quranic text without a need to extensively review the output to identify, mark, and control the loss of material or the inadvertent addition of material to the output from imaging the Quranic text. For example, dust or other particles from the environment may land on the pages of the Quranic text and then be imaged along with the original text to create artifacts, such as markings that may be confused with “dots” or other items used in the Quranic text. Also, characteristics of the equipment used, such as lenses, shutters, moving parts, page movement, and other imperfections in the equipment may cause the introduction of unintended markings or the failure to copy (or print) intended markings (i.e., extra “dots” or missing “dots”).

Thus, the invention is needed to manage the artifacts in output when imaging and/or printing the Holy Quran. First, efforts are made, such as brushing or blowing across the original page to remove surface dust to limit added markings in the subsequently scanned image. Also, the equipment may function with the appropriate software instructions to pre-process the original text (without touching the original text) to survey the page to calibrate and adjust to prepare the system for properly scanning the original to avoid adding or omitting markings during the scanning process. Then, the system may proceed to scan the original image in one pass or multiple passes to enhance the quality of the scanning process and to avoid errors. Post-processing steps may be used. After the image is gathered, one may choose to not remove any extraneous markings but to mark the extraneous markings, such as in the color red, to readily indicate to the reader that the particular marking is not part of the original Quranic text. Additionally, if certain original markings are omitted, the system may function to add back the omitted marking, in a particular color, such as in the color blue, to readily indicate to the student that the particular marking is a part of the original Quranic text but had been lost in the scanning or printing process but now restored. In a broader sense, using scanners that require a flipping page arm, may also result in a whole page being skipped from scanning, which also in turn results in a scanned copy of the Quran without a page and being defective.

Ultimately, the goal is to have printed versions of the Holy Quran which are perfect and without any artifacts. Other artifacts that can find their way onto the printed version of the Holy Quran may also be dust, ink, or paper imperfections that may result in a stray dot on the Arabic letter, resulting in a completely different letter and word with a different meaning. (It is preferred that the pages cleaned before being scanned to exclude dust or any flying objects; hair from being scanned by using a brush or an ionized air blower.)

Referring to FIG. 15, an example of three Arabic letters is shown as “ [symbol] ”, “ [symbol] ”, “ [symbol] ” which as clearly seen, the presence and position of the dot “.” will result in having three different letters resulting in a word having three different or no meaning at all. Such dots can easily find their way in the scanned copy as a result of an artifact or ink blotch or scanning quality. As indicated with reference to FIGS. 11 and 12, the artifacts can be identified by “blue squares” on the left side on the black background for a very quick visual identification as a result of quality review.

Referring to FIG. 16, a flow chart representing the steps required for the printing, and then scanning and quality review by making the comparison using the software and system is disclosed.

Referring to FIG. 17, an alternative embodiment of the book scanner 10′ for the Holy Quran is illustrated in which the sheet of the printed Holy Quran can be scanned flat.

Referring to FIG. 18, a flow diagram is shown which represents the steps required to make the comparison of the scanned Holy Quran scanned using a flat book scanner, such as the scanner shown in FIG. 15.

The following is an example of the steps which may be used in the software for detecting artifacts and errors in printing. First, the original version of the text is prepared. As indicated above, the original perfect copy is commercially available in many different digital formats. The original text is resized to a specific size. This can be done, for example, with bilinear interpolation to preserve scaling. A Gamma for the original text is corrected. The Gamma coefficient can be, for example, 1.4. The original text is converted to black and white. This step may require treating anything lighter than 59% as white. Features of the original text are found. Test text is created. Feature from the original to the test text are compared. Unique features from the original and the test text are combined into an image format, for example, any digital format, and the differences between the two images highlighted.

Gamma correction is well known. For example, as set forth in Wikipedia gamma correction, gamma nonlinearity, gamma encoding, or often simply gamma, is the name of a nonlinear operation used to code and decode luminance or tristimulus values in video or still image systems. Gamma correction is, in the simplest cases, defined by the following power-law expression:

Vₒᵤₜ=AVᵢₙ^{γ}

where A is a constant and the input and output values are non-negative real values; in the common case of A=1, inputs and outputs are typically in the range 0-1. A gamma value γ<1 is sometimes called an encoding gamma, and the process of encoding with this compressive power-law nonlinearity is called gamma compression; conversely a gamma value γ>1 is called a decoding gamma and the application of the expansive power-law nonlinearity is called gamma expansion.

The present invention also utilizes software that is identified as SURF. Different libraries such as OPENCV that have Surf within them are available to the public as are different algorithms which do the same functionally. The algorithms can be downloaded from http://opencv.org/downloads.html, SURF—Wikipedia, the free encyclopedia and http://docs.opencv.org/trunk/doc/py_tutorials/py_feature2d/py_surf_intro/py_surf_intro.html.

The functional steps for a programmer to complete a program utilizing SURF are as follows:

SURF parameters will be: hessian threshold=500 keypoints, results are described by 64 points (one found robust feature=64 points)
img1=original image, source we compare to
Resize img1 to 1000×1500 pixels using linear resizing
Correct Gamma for img1 with parameter 1.4
Convert img1 to black-and-white (everything darker than 41% is black, the rest is white)
Find features for img1 using SURF (parameters at the top)
img2=tested image, we compare it to img1
Resize img2 to 1000×1500 pixels using linear resizing
Correct Gamma for img2 with parameter 1.4
Convert img2 to black-and-white (everything darker than 41% is black, the rest is white)
Find features for img2 using SURF (parameters at the top)
Match features assuming img1 is a model and img2 is an observed image. We are looking for 2 neighbors for each feature and visit up to 20 leaves
filter matched features by uniqueness: features are “equal” if they match on 95% points
filter matched features by size: features are “equal” only if their sizes are different not more than on 1.5×
filter matched features by orientation: features are “equal” only if they have not more than 20 bins of rotation (18 degrees per bin)
now we count number of matched features after filtering and compare to total amount of features in img1 or img2 whichever is greater.
to prepare comparison image we do the following
Recover the homography matrix using RANDSAC.
result=empty image (sizes of img2)
result[green channel]=fill using homography matrix so matched features becomes green
result[blue channel]=fill with img2 (so black becomes blue)
result[red channel]=fill with red only pixels where result[blue channel] not equal to result[green channel] so different between img2 and matched features becomes red
mask=grey shades image with brightness equal to [negative blue AND negative green channels of result]
dilate mask 5 times with 3×3 elements
result[red channel]=result[red channel] multiplied by negative mask using scale 1/255
convert result[red channel] to black-and-white image (everything darker 31% becomes black)
dilate result[red channel] 10 times with 3×3 elements
display color image result

Alternative programs and algorithms to SURF which could also be used. The name and related documentation available on the web are as follows:
Harris corner detector
   (courses.cs.washington.edu/courses/cse577/05sp/notes/harris.pdf
   www.icu.uci.edu/˜dramanan/teaching/cs27.../lec/features.pdf
Harris-Laplace—scale-invariant version of Harris detector.
   http://vasc.ri.cmu.edu/˜hebert/04AP/mikolajc_ECCV2002.pdf
   http:www.robots.ox.ac.uk/˜vgg/research/affine/det_eval_files/vibes_ijcv2004.pdf
Multi-Scale Oriented Patches (MOPs)
   http://research.microsoft.com/pubs/70120/tr-2004-133.pdf
LoG filter—since the patented SIFT uses DoG (Difference of Gaussian) approximation of LoG (Laplacian of Gaussian) to localize interest points in scale, LoG alone can be used in modified, patent-free algorithm, tough the implementation could run a little slower
   jhhorng.myweb.hinet.net/pdf/Laplacian-of-Gaussian.pdf
   www.ijcsi.org/papers/IJCSI-9-1-1-269-276.pdf
FAST
BRISK (includes a descriptor
www.robots.ox.ac.uk/˜vgg/rg/papers/brisk.pdf
http://www.asl.ethz.ch/people/lestefan/personal/BRISK
http://savvash.blogspot.com/2011/08/brisk-binary-robust-invariant-scalable.html
ORB (includes a descriptor)
   Keypoint descriptor:
Normalized gradient—simple, working solution too simple to has a paper about it, Similar to Histogram of Oriented gradients
Wavelet filtered image patch—similar to gradient, the details are given in MOPs paper, but can be implemented differently to avoid the patent issue (e.g. using different wavelet basis or different indexing scheme)
   www.csee.wvu.edu/˜xinl/papers/li_main.pdf
Histogram of oriented gradients
   http://en.wikipedia.org/wiki/Histogram_of_oriented_gradients
   http://www.pascal-network.org/challenges/VOC/voc2006/slides/dalal.pdf
   http://lear.inrialpes.fr/people/triggs/pubs/Dalal-cvpr05.pdf
GLOH
   en.wikipedia.org/wiki/GLOH
   www.matthewajohnson.org/pdfs/johnson10generalized.pdf
   http://lear.inrialpes.fr/pubs/2005/MS05/milolajczyk_pami05.pdf
LESH Local Energy based Shape Histogram
   http://en.wikipedia.org/wiki/LESH
   http://www.cv.tu-berlin.de/fileadmin/fg140/Head_Pose_Estimation.pdf
FREAK
   infoscience.epfl.ch/record/175537/files/2069.pdf
   http://www.computersdontsee.net/index.php/post/2012/06/20/Introducing-FREAKs
   http://docs.opencv.org/modules/features2d/doc/feature_detection_and_description.html#freak-freak
   Free library: opencv, emgu, CImg, library, OpenSurf. (opencv is most widely used, others a kind of sub-set or special on certain algorithm).
   Non-Free: IPP, eVision. HALCON
   IPP is published by Intel, the algorithm is optimized for Intel CPU, which claimed to be fastest. However, opencv already uses IPP library in its development.

The process of scanning and making the comparison using the claimed invention can be done at different stages of the printing of the Holy Quran. For example, the comparison process using the system and software can be during the printing process of the Holy Quran, it could be done before the folding, it could be done after the folding, and it could be done after the final Holy Quran is combined with the hard cover.

Moreover, it is also noted that even the offset printing plates, which over time can have defects and artifacts, can be used instead of the scanned format of the printed Holy Quran for the purposes of making the comparison.

Also, the system and software can be used on an already existing and/or older printed Holy Quran which may include markings or defects by the user, such as, but not limited to, pen markings or underlining of the text.

While the invention has been described in connection with some embodiments, it should be recognized that changes and modifications may be made therein without departing from the scope of the appended claims.

1. A method for verifying the accuracy of a printed copy of Arabic documents from a digital master image comprising the following steps:
situating a scanner with an Arabic document in a preparatory position relative to a book support member, for scanning;
cleaning a page of the Arabic document before scanning;
scanning the Arabic document;
preparing a digital master image of the Arabic document comprising gray images and sizing the digital master image to preselected dimensions using a computer;
making gamma corrections and converting the gray images to black images or white images, using a computer;
comparing a printed copy of the digital master image with said digital master image and marking differences to indicate artifacts and omissions, using a computer.

2. The method for verifying the accuracy of a printed copy of Arabic documents from a digital master image according to claim I, in which artifacts and omissions are indicated with different colors.

3. The method for verifying the accuracy of the copy of Arabic documents from a digital master image according to claim 2, further comprising displaying the gamma corrections side-by-side.

4. A system for verifying the accuracy of a printed copy of Arabic documents from a digital master image, the system comprising:
at least one processor; and
a non-transitory computer readable medium connected to the at least one processor, wherein the at least one processor is configured to execute a set of instructions for:
situating a scanner with an Arabic document in a preparatory position relative to a book support member, for scanning;
cleaning a page of the Arabic document before scanning;
scanning the Arabic document;
receiving a digital image of the scanned Arabic document and sizing the digital image to preselected dimensions;
making gamma corrections to the digital image of the Arabic document and converting any gray images to black images or white images;
comparing the scanned image of the Arabic document with the received digital image; and
marking differences between the scanned image and the digital image to indicate artifacts or omissions.

5. The system for verifying the accuracy of a printed copy of Arabic documents from a digital master image according to claim 4, in which differences in artifacts are indicated in a first color and differences in omissions are indicated in a second color.

6. The system for verifying the accuracy of a printed copy of Arabic documents from a digital master image, according to claim 5, in which the first or second color is superimposed on each artifact or omission.

7. A system for verifying the accuracy of the text in a copy of the Holy Quran from a digital master image, said system comprising of:
at least one processor; and
a non-transitory computer readable medium connected to the at least one processor, wherein the at least one processor is configured to execute a set of instructions for:
situating a scanner, with a triangular scanning head, with copy of the Holy Quran in a preparatory position, for scanning;
blowing air across a page of the Holy Quran before scanning;
scanning the Holy Quran to produce a scanned image of the Holy Quran;
receiving the digital image of the Holy Quran and sizing the digital image to preselected dimensions;
comparing the scanned image of the copy of the Holy Quran with the received digital image of the Holy Quran; and
marking differences between the scanned image and the received digital image to indicate artifacts or omissions.

8. The system for verifying the accuracy of the text in a copy of the Holy Quran from a digital master image according to claim 7, in which differences in artifacts are indicated by a first color and differences in omissions are indicated in a different color.

9. The system for verifying the accuracy of the text in a copy of the Holy Quran from a digital master image according to claim 7, in which the first and second colors are superimposed on said artifacts and omissions.

10. (canceled)

11. A system for verifying the accuracy of the text in a copy of the Holy Quran from a digital master image, said system comprising of:
at least one processor; and
a non-transitory computer readable medium connected to the at least one processor, wherein the at least one processor is configured to execute a set of instructions for:
situating a scanner, with a triangular scanning head, with copy of the Holy Quran in a preparatory position, for scanning;
blowing air across a page of the Holy Quran before scanning;
scanning the Holy Quran to produce a scanned image of the Holy Quran;
receiving the digital image of the Holy Quran and sizing the digital image to preselected dimensions;
storing a perfect copy parameter in the non-transitory computer readable medium;
storing a scanned copy parameter In the non-transitory computer readable medium;
storing a display preferences parameter in the non-transitory computer readable medium;
comparing the scanned image of the copy of the Holy Quran with the received digital image of the Holy Quran;
determining whether any inaccuracy, omissions, or additions are present in the scanned image based on the perfect copy parameter and the scanned copy parameter; and
storing any inaccuracies, omissions, or additions in the non-transitory computer readable medium as identified artifacts parameters.

12. The system for verifying the accuracy of the text in a copy of the Holy Quran from a digital master image of claim 11, further comprising:
executing a set of instructions for modifying the scanned copy parameter to highlight identified artifacts based on the display preferences parameter.

13. The system for verifying the accuracy of the text in a copy of the Holy Quran from a digital master image of claim 11, further comprising:
executing a set of instructions for displaying information stored in the perfect copy parameter, the scanned copy parameter, and the identified artifacts parameter, based on the display preferences parameter, to a user.
